(19) United States
(12) Patent Application Publication
(10) Pub. No.: US 2011/0060823 A1
(43) Pub. Date: Mar. 10, 2011

(54) NETWORK-ASSISTED HEALTH REPORTING ACTIVATION

(75) Inventors: Bryan Phillippe, Sammamish, WA (US); Christopher Boscolo, Bellevue, WA (US)

(73) Assignee: Napera Networks, Inc., Mercer Island, WA (US)

(21) Appl. No.: 12/751,921

(22) Filed: Mar. 31, 2010

Related U.S. Application Data
(60) Provisional application No. 61/165,438, filed on Mar. 31, 2009.

(51) Int. Cl. G06F 15/173

(52) U.S. Cl. 709/224

(57) ABSTRACT

A system and method for generating and tracking health diagnoses of devices connected to a computer network via a statement of health provided by each device. The system monitors the health of devices on the network and attempts to engage the operator of undiagnosed devices in order to provide a diagnosis. Undiagnosed devices are quarantined to restrict their access to network resources. For example, access requests from quarantined devices to certain Web services may be intercepted and the device redirected to a page informing the operator of the need to provide a health diagnosis by installing or activating a compatible system health agent.

### CROSS-REFERENCE TO RELATED APPLICATION

This application claims the benefit of U.S. Provisional Application No. 61/165,438 entitled “NETWORK-ASSISTED HEALTH REPORTING ACTIVATION,” filed on Mar. 31, 2009, which is incorporated herein by reference in its entirety.

### BACKGROUND

Network Access Control (NAC) technology provides the ability for a network appliance (such as an Ethernet switch) to enforce network access restrictions based on some administratively-defined access policy. These restrictions could include, for example, limiting the types of protocols, network services, servers, or other network devices that a connected device is permitted to access.

In a typical NAC deployment, the NAC enforcement appliance must make a decision about whether and how to enforce access control based on information the connected devices provide to the NAC enforcement appliance via the network. An example of this might be user-based authentication—the NAC device might only allow full network access if a user of the connecting device has authenticated to the network and has the appropriate access privileges.

### BRIEF DESCRIPTION OF THE DRAWINGS

FIG. 1 is a block diagram illustrating some components of an environment in which the facility operates.

FIG. 2 is a block diagram showing some of the components typically incorporated in at least some of the computer systems and other devices on which the facility executes.

FIG. 3 is a block diagram illustrating components of health enforcement node in some embodiments.

FIG. 4 is a table diagram illustrating sample contents of a device health store in some embodiments.

FIG. 5 is a flow diagram illustrating steps performed by a health diagnosis component of the health enforcement node in some embodiments.

FIG. 6 is a flow diagram illustrating steps performed by an access request processing component of the health enforcement node in some embodiments.

FIG. 7 is a flow diagram illustrating steps performed by an alert component of a computing device managed by the facility in some embodiments.

FIG. 8 is a display diagram illustrating a display page that may be presented to an operator of a device to alert the operator that the device is unhealthy or undiagnosed.

### DETAILED DESCRIPTION

In some possible NAC implementations, connected devices or hosts are made capable of providing “health” information about their security settings by way of a software application called a “system health agent.” The system health agent must be installed and active on the connecting devices in order to provide the health information necessary for the NAC enforcement appliance to make an access control decision. The NAC enforcement appliance cannot obtain health information from devices that do not have an active system health agent configured to report health information for the device installed. The inventors have recognized the desirability of prompting operators of devices to enable health reporting at the devices.

Accordingly, a facility for tracking and enabling health diagnoses of devices connected to a computer network is described. The facility is composed of software and/or hardware, and provides the ability to track and enable health diagnoses of devices on a computer network in a health enforcement node. In some embodiments, the facility uses a health enforcement node—such as a network appliance located in the network—to observe and intercept certain network protocols exchanged over the network. An example of such a network appliance is the Napera N24 network switch.

The facility includes a health enforcement node that diagnoses the health of a device by evaluating “Statement of Health” data (SoH) sent from the device. The health enforcement node may be integrated with a network-switching device capable of exposing address-level (e.g., MAC, IP) Access Control List application programming interfaces (APIs) for the facility to manipulate and/or trapping communications using selected protocols for the facility to inspect (e.g., HTTP).

The facility further includes a system health agent present on devices on the network that generates and advertises a SoH for an associated device. Examples of system health agents capable of generating a SoH that is recognizable by the facility include Microsoft's Network Access Protection (“NAP”—present in Windows Vista and Windows XP SP3), Napera's Health Agent for the Macintosh, and so on.

A SoH contains information about the state of a variable number of security components that are supported by the device, such as:
Personal Internet Firewall—disabled, enabled, and/or a manifest of options/settings;
Anti-virus—disabled, enabled, or enabled and up-to-date, and/or a manifest of options/settings;
Anti-spyware—disabled, enabled, or enabled and up-to-date, and/or a manifest of options/settings;
OS Automatic Updates—disabled, enabled, or enabled and up-to-date (no outstanding vendor-recommended patches); and
Automatic Login—allowed or disallowed.

Generally, a SoH-capable device presents its SoH when it is requested by a SOH-consuming device on the network, such as a SoH-aware DHCP server or an 802.1x authentication server. Examples of such SOH-consuming devices include Microsoft's Windows Server 2008 and Napera's N24 network switch. In some embodiments, a SoH-capable device may advertise its SoH on the network periodically while it is connected to the network and/or when it connects to the network.

In some embodiments, where operating in a network without a SoH-consuming device, the health enforcement node acts as a SoH-consuming device. Additional details are provided by U.S. patent application Ser. No. ______ (patent counsel's docket no. 65985.8002US01) entitled “MANIPULATION OF DHCP PACKETS TO ENFORCE NETWORK HEALTH POLICIES” filed concurrently herewith, and U.S. Provisional Patent Application No. 61/165,423 entitled “TRANSPARENT MANIPULATION OF DHCP PACKETS CONTAINING SOH DATA TO ENFORCE NETWORK HEALTH POLICIES,” filed on Mar. 31, 2009.

When a health enforcement node observes a SoH from a device, the health enforcement node diagnoses the device (i.e., determines the health of the device) by comparing the SoH to a predefined security policy. For example, a security policy may require that a device have both an enabled firewall and up-to-date anti-virus software. Any device that advertises a SoH indicating that the device does not satisfy these requirements may be deemed unhealthy. The facility generally treats diagnosed devices based upon the contents of their SoH. Generally, the more positive a diagnosed device's SoH is, the greater the access rights and other capabilities the facility will grant to the diagnosed device. Where a diagnosed device's SoH has a particular deficiency, the facility may withhold a particular related capability and/or pursue remediation of the deficiency. For example, a device without anti-spyware software may be prevented from accessing websites known for loading spyware on the devices. As another example, a device that has not installed a particular vendor-recommended patch may be directed to a website to download and install the outstanding patch before resuming other activities on the network. In some embodiments, the facility may report the health of the device and allow the device to continue accessing the network without affecting the access rights of the device. For example, when the facility observes traffic from an unhealthy device, the facility may notify an operator of the device or a network administrator that the device is unhealthy. As another example, the facility may redirect a device to a web page indicating that the device is unhealthy and allow the operator of the device to click a link that allows the operator to bypass health reporting for some period of time. In this manner, the operator and/or network administrator and made aware of the health of the device and can take appropriate actions to bring the device into compliance (i.e., correct the health of the device).

The facility maintains a persistent, global table of device addresses and health diagnosis states for connected devices. The facility may add an entry to the table for a device, for example, when the device advertises a SoH to the network or when the device begins communicating on the network. For example, when a device connects to the network or begins to exchange data with other devices over the network, its Ethernet MAC address becomes visible to the facility. The facility may then add this MAC address to the table and begin tracking the device via this address along with an associated health diagnosis for the device. If the facility has not observed a health diagnosis for a device or a diagnosis for the device has become invalid or expired, then the device is considered to have an “undiagnosed” health status. The facility may not have observed a valid SoH for a device for several reasons. For example, the device may not have a system health agent and therefore be unable to generate a SoH, the system health agent on the device may be inactive or disabled, the facility may have lost track of the last SoH advertised by the device, the health enforcement node may not have been present or active when the last SoH was advertised, the SoH may have expired, etc.

The facility may “quarantine” devices with an undiagnosed health status from the rest of the network. Assuming the health enforcement node is located in a position to affect or intercept network traffic between the device and the remainder of the network (for example, if the health enforcement node is present on a network switch), then the health enforcement node will not allow the device to access the remainder of the network or may provide limited access to the remainder of the network. For example, the health enforcement node may permit traffic needed for basic interoperability of the connected devices (e.g., ARP, DNS, or DHCP). In some embodiments, the facility may automatically bring unhealthy devices into compliance. For example, the facility may cause the device to download and install a patch to update anti-virus or anti-spyware software on the device so that the software is up-to-date. As another example, the facility may cause the activation of a disabled firewall on the device without operator intervention.

In some embodiments, the health enforcement node intercepts all World Wide Web (Web) accesses from undiagnosed devices for the purpose of obtaining, or attempting to obtain, a diagnosis by accepting connection attempts from the quarantined device to any destination address. As an example, for each HTTP resource requested by the device, the health enforcement node may return an HTTP redirect, such as an HTTP 302 Found—“Temporary Redirect”—response, specifying a destination on the health enforcement node. This destination redirects the device's Web access to a “Captive Web Portal” page provided by the health enforcement node. If the initiating web client on the undiagnosed device is a web browser, then it will automatically follow the redirect and load the Captive Web Portal page, which contains graphical and textual instructions for the operator (the person using the web browser). The instructions explain that the device has been put into quarantine because of a lack of a health diagnosis because the device has been diagnosed as unhealthy. The instructions also point to an application that can be downloaded and run on the device for the purpose of either installing a system health agent, activating or enabling an existing system health agent, or prompting an enabled health agent to advertise a SoH. If the operator chooses to download and execute the application, the device will automatically advertise a SoH, have its health diagnosed by the health enforcement node, and have its Web access enabled in accordance with the health diagnosis.

In addition to providing the operator with an application or instructions for the purpose of obtaining a health diagnosis for the device, in some embodiments the Captive Web Portal page provides an option for the operator to explicitly proceed without a health diagnosis. If the operator chooses this option, the device will remain undiagnosed, will no longer have its Web traffic intercepted by the facility for the purpose of obtaining a diagnosis, and will be subject to a default access policy that the facility enforces for undiagnosed devices. After a period of inactivity on the network, the facility will resume interception of Web traffic from the undiagnosed device for the purpose of obtaining a diagnosis, allowing the operator an opportunity to again establish health reporting for the device.

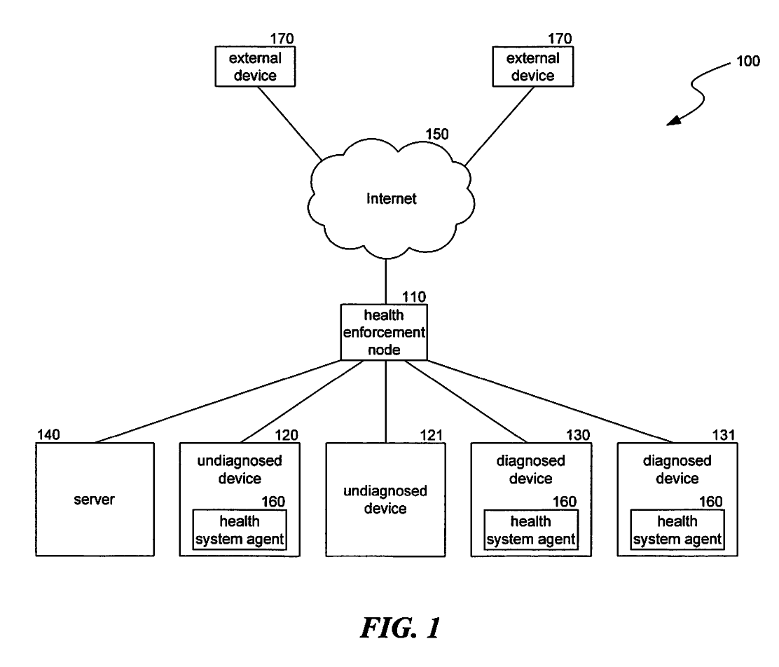

FIG. 1 is a block diagram illustrating some components of an environment 100 in which the facility operates. In this example, the environment 100 includes health enforcement node 110, undiagnosed devices 120 and 121, diagnosed devices 130 and 131, server 140, Internet 150, and external devices 170. In this example, health enforcement node 110 enforces health polices for undiagnosed devices 120 and 121 and diagnosed devices 130 and 131, or the “managed devices.” Health enforcement node 110 also generates health diagnoses for managed devices and a set of access privileges for those devices based on a SoH received from each device. When the health enforcement node determines that a managed device is unhealthy or undiagnosed, the health enforcement node quarantines the device from the network to restrict that device's access to network components. Health enforcement node 110 also monitors access requests from managed devices and allows or denies those requests in accordance with access privileges associated with the device. Diagnosed devices 130 and 131 are devices for which the health enforcement node has a valid health diagnosis while undiagnosed devices 120 and 121 are devices for which the health enforcement node does not have a valid diagnosis. The health enforcement node generates health diagnoses by processing a SoH sent from the device and generated by system health agent 160. In this example, undiagnosed device 121 does not include a system health agent and, therefore, has not provided a SoH to the health enforcement node. Although undiagnosed device 120 includes a system health agent 160, the health enforcement node does not have a valid diagnosis for the device because, for example, the system health agent is disabled or a previously generated diagnosis has expired. Health enforcement node 160 may also manage communications between the managed devices and other connected devices such as server 140 or devices that are not directly connected to the health enforcement node, such as external devices 170, via Internet 150.

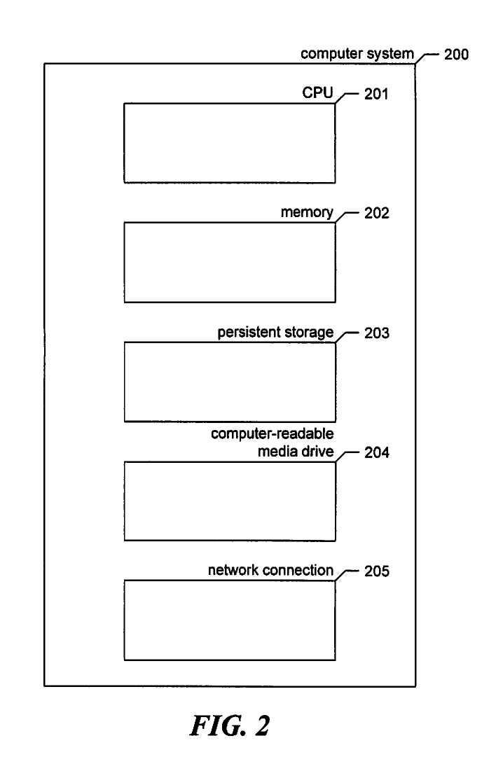

FIG. 2 is a block diagram showing some of the components typically incorporated in at least some of the computer systems and other devices on which the facility executes. These computer systems and devices 200 may include one or more central processing units (“CPUs”) 201 for executing computer programs; a computer memory 202 for storing programs and data—including data structures, database tables, other data tables, etc.—while they are being used; a persistent storage device 203, such as a hard drive, for persistently storing programs and data; a computer-readable media drive 204, such as a CD-ROM drive, for reading programs and data stored on a computer-readable medium; and a network connection 205 for connecting the computer system to other computer systems, such as via the Internet or another network and its networking hardware, to exchange programs and/or data—including data structures. In various embodiments, the facility can be accessed by any suitable user interface including Web services calls to suitable APIs. While computer systems configured as described above are typically used to support the operation of the facility, one of ordinary skill in the art will appreciate that the facility may be implemented using devices of various types and configurations, and having various components, such as wireless telephones and similar devices.

The computing devices on which the facility is implemented may include input devices (e.g., keyboard and pointing devices), output devices (e.g., display devices), and storage devices (e.g., disk drives, flash drives). The memory and storage devices are computer-readable media that may be encoded with computer-executable instructions that implement the facility, which means a computer-readable medium that contains the instructions. In addition, the instructions, data structures, and message structures may be stored in a data storage medium or transmitted via a data transmission medium, such as a signal on a communications link, and may be encrypted. Various communications links may be used, such as the Internet, a personal area network, a local area network, a wide area network, a point-to-point dial-up connection, a cell phone network, and so on.

Embodiments of the facility may be implemented in and used with various operating environments that include personal computers, server computers, handheld or laptop devices, multiprocessor systems, microprocessor-based systems, programmable consumer electronics, digital cameras, network PCs, minicomputers, mainframe computers, computing environments that include any of the above systems or devices, and so on.

The facility may be described in the general context of computer-executable instructions, such as program modules, executed by one or more computers or other devices. Generally, program modules include routines, programs, objects, components, data structures, and so on that perform particular tasks or implement particular abstract data types when executed by a processor. Typically, the functionality of the program modules may be combined or distributed as desired in various embodiments.

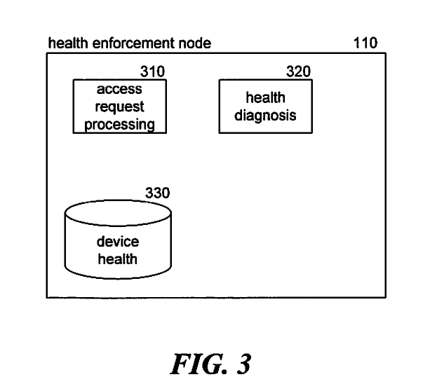

FIG. 3 is a block diagram illustrating components of health enforcement node 110 in some embodiments. In this example, health enforcement node 110 includes an access request processing component 310, a health diagnosis component 320, and a device health store 330. Access request processing component 310 determines whether an access request is to be allowed or denied and is invoked when a managed device requests access through the health enforcement node. Health diagnosis component 320, which diagnoses a managed device and generates access privileges for healthy managed device based on the device's SoH, is invoked when the health enforcement node receives an indication of an advertised SoH from a managed device. Device health store 330 stores information pertaining to the health of the managed device, such as whether or not a SoH has been received and access privileges associated with the device.

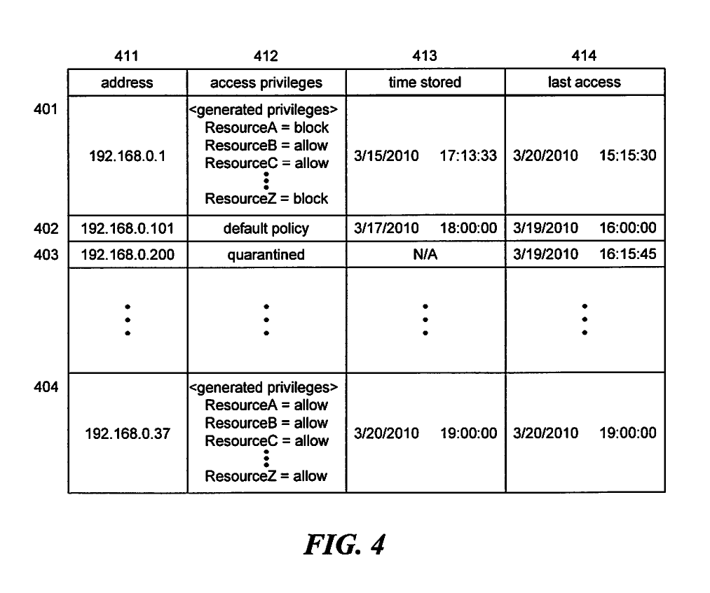

FIG. 4 is a table diagram illustrating sample contents of a device health store in some embodiments. Table 400 contains rows, such as rows 401-404, each corresponding to a device managed by the health enforcement node of the facility. Each row is divided into the following columns: an address column 411 containing an address associated with the device, such as an IP address or a MAC address; an access privileges column 412 that contains an indication of the device's access privileges, such as a list of privileges generated based on the device's SoH, a default access policy, or an indication that the device is quarantined; a time stored column 413 containing an indication of when the access privileges were stored; and a last access column 414 containing an indication of the time at which the device last accessed the network. For example, row 401 indicates that the health enforcement node stored generated privileges for a device at IP address 192.168.0.1 at 17:13:33 on Mar. 15, 2010 and that the device last accessed the network at 15:15:30 on Mar. 20, 2010. In various embodiments, the health enforcement node generates access privileges for a device based on a SoH received from the device. For example, if the SoH for a device indicates that the device has up-to-date anti-virus software but does not have any anti-spyware software, the health enforcement node may generate privileges that prevent the device from accessing network resources that may be susceptible to spyware or resources that may cause spyware to be downloaded to the device. The generated privileges stored in row 401 indicate that the associated device is allowed to access resources ResourceB and ResourceC but is blocked from resources ResourceA and ResourceZ. These resources may represent various types of resources available to the device via the network, such as a node on the network, a node external to the network, an application executing or stored on an accessible node, data stored on an accessible node, a branch of the network, etc. One skilled in the art will recognize that while FIG. 4 provides an illustration that is easily comprehensible by a human reader, the actual information may be stored in any manner.

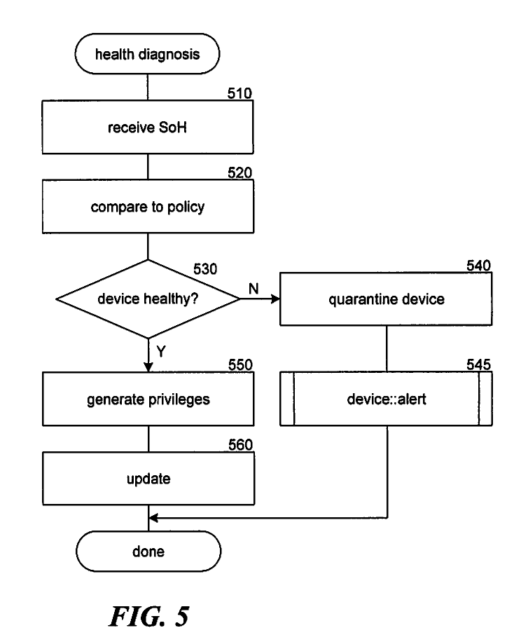

FIG. 5 is a flow diagram illustrating steps performed by the health diagnosis component of the health enforcement node in some embodiments. The component diagnoses a managed device and generates access privileges for a healthy device based on the device's SoH. In step 510, the component receives the SoH from an advertising device. Common methods of exchanging a SoH include via DHCP vendor-extension used during dynamic address assignment, and EAP exchange used during 802.1x or PPTP user authentication. Devices on the network that observe a SoH but are not aware of its purpose (i.e. are not SoH-aware) will generally ignore a SoH. In step 520, the component compares the received SoH to a security policy indicating security rules used to determine whether a device is healthy or unhealthy. For example, the security policy may specify, among other things, that a device must have an enabled firewall and up-to-date anti-spyware software to be deemed healthy. In step 530, if the device is healthy then the component continues at step 550, else the component continues at step 540. In step 540, the component quarantines the device to restrict the device's access to network resources. In step 545, the component alerts the operator of the device that the facility has quarantined the device and then completes. For example, the component may direct the device to a Captive Web Portal page or send an email to the operator of the device indicating that the device is unhealthy and further indicating steps that may performed to improve the health of the device.

In step 550, the component generates privileges for the device based on the device's SoH. For example, if the SoH indicates that the device meets each requirement in the security policy, the component may give the device full access to network resources. In some embodiments, a security policy may specify a number of optional security features. The facility may generate access privileges for the device based on the number of optional security features that the device includes. For example, a device that includes anti-virus software but that does not include the most current patches for the anti-virus software may not be quarantined but may be limited in the number of devices or services that it may access. In step 560, the component updates the device health store by, for example, adding or updating an entry for the device including an address, an indication of the generated privileges, the time at which the privileges were stored, and the time the device accessed the network. The component then completes.

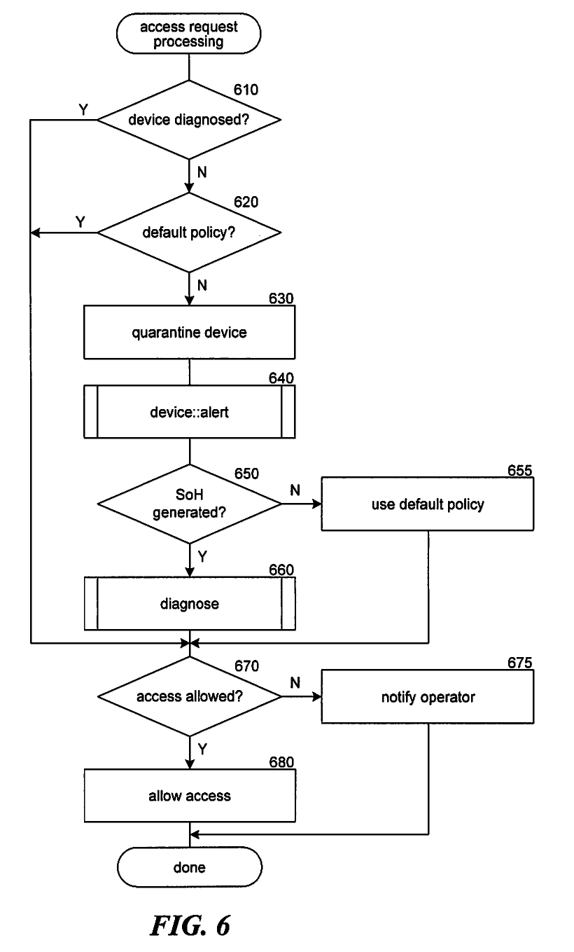

FIG. 6 is a flow diagram illustrating steps performed by an access request processing component of the health enforcement node in some embodiments. The component is invoked when the health enforcement node receives a request to access a resource from a managed device. In step 610, if the device has been diagnosed and the diagnosis has not expired, then the component continues at step 670, else the component continues at step 620. In step 620, if the device is using a default access policy and the default access policy has not expired, then the component continues at step 670, else the component continues at step 630. In step 630, the component quarantines the device. In step 640, the component alerts the operator of the device that the device has been quarantined. For example, the component may direct the device to a web page, or send an email to the operator of the device, indicating that the device is unhealthy and steps that may performed to improve the health of the device. In step 650, if the alert resulted in the generation of a SoH for the device, then the component continues at step 660, else the component continues at step 655. In step 655, the component associates the device with the default access policy, updates the device health store accordingly, and then continues at step 670. In step 660, the component invokes the health diagnosis component to diagnose the device based on the generated SoH. In step 670, if the requested access is allowed, then the component continues at step 680, else the component continues at step 675. In step 675, the component notifies the operator that the requested access was not allowed and then completes. In step 680, the component allows the requested access and then completes.

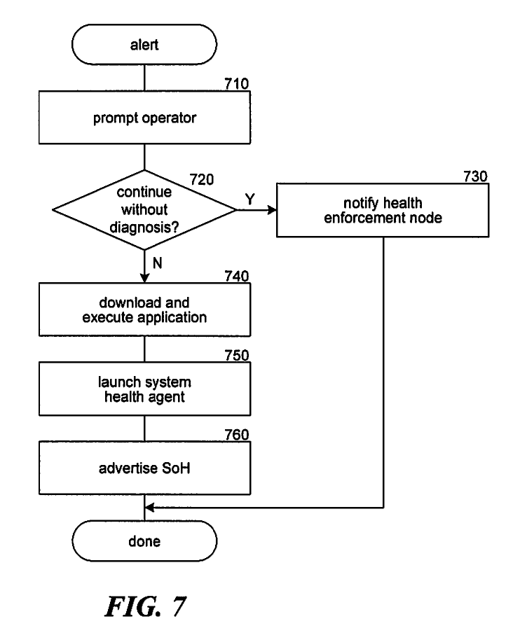

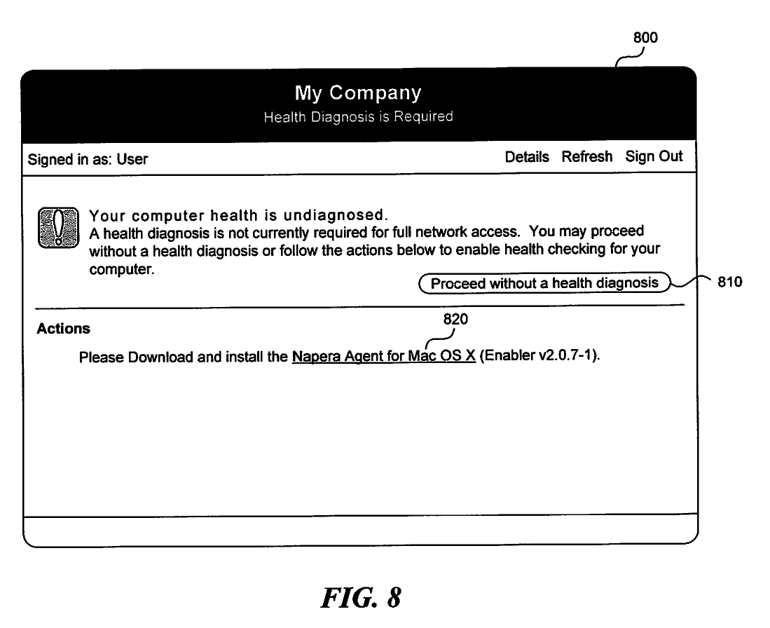

FIG. 7 is a flow diagram illustrating steps performed by an alert component of a computing device managed by the facility in some embodiments. The component is invoked to notify an operator of the device that the device is unhealthy or undiagnosed and present an opportunity for the operator to take action to remedy this situation. In step 710, the component prompts the operator. For example, the component may direct a web browser on the device to a Captive Web Portal page that notifies the operator that the device is unhealthy or undiagnosed and provides the operator with a list of options for proceeding, such as diagnosing the device, curing the device, or proceeding without diagnosing and reporting the health of the device. FIG. 8, described below, shows a sample Captive Web Portal page.

In various embodiments, the facility provides one or more mechanisms other than the Captive Web Portal through which the facility may interactively engage the operator for the purpose of obtaining a health diagnosis. If the operator of the device is not using an interactive web browser, in some embodiments the facility to uses email to alert the operator of the device or the administrator of the network appliance on which the facility resides. Such an alert serves the purpose of advising the operator of the undiagnosed device that network access is limited for this reason, as well as proving the operator with the instructions and/or software necessary to enable health reporting. The email address of the operator of the undiagnosed device can be determined in several possible ways. For example, the MAC address of the undiagnosed device may already be associated with a username corresponding to a local email address. As another example, if the operator has logged onto the network or otherwise authenticated over the network, the facility may have access to the username associated with the undiagnosed device, and therefore an associated local email address. Because the facility is in a position to intercept the SoH traffic and HTTP requests from the undiagnosed device, it is also likely in a position to intercept (or at least passively observe) user authentication from the undiagnosed device. Similarly, if the facility is in a position to intercept HTTP requests from the undiagnosed device, it is also likely in a position to intercept SMTP, POP, or IMAP traffic (email) from the undiagnosed device. In some embodiments, the facility observes the sender email address in outgoing emails that the undiagnosed device attempts to send and uses them to send the alert. Furthermore, the operator may be alerted by, for example, an instant message, Short Message Service (SMS) message, etc.

In step 720, if the operator selects to continue without a diagnosis, then the component continues at step 730, else the component continues at step 740. In step 730, the component notifies the health enforcement node that the operator has indicated to use a default access policy and then completes. In this manner, the health enforcement node can update the device health store by, for example, recording that the operator has chosen to use the default access policy and the time at which the operator selected the default access policy. In some embodiments, the operator's selection may expire after a predetermined amount of time, such as 30 minutes of inactivity, 1 hour, etc. or at the end of a current session so that operators of the device can be re-prompted to initiate a diagnosis for the device.

In step 740, the component downloads and executes an application that checks the state of any health system agent on the device and, if no health system agent is present on the device, downloads and installs a health system agent on the device. In step 750, the component launches the health system agent on the device so that the health system agent can generate a SoH for the device. In step 760, the component advertises the generated SoH for the device to the network so that the health enforcement node can diagnose the device. The component then completes.

FIG. 8 is a display diagram illustrating a display page 800 that may be presented to an operator of a device to alert the operator that the device is unhealthy or undiagnosed. The display page may be presented in any form, such as a web page, email message, instant message, SMS message, dialog box, etc. In this example, display page 800 includes proceed button 810 and download application link 820. When an operator selects proceed button 810, the operator is allowed to continued using the device without a health diagnosis. As described above, when an operator chooses to proceed without a health diagnosis, the facility applies a default access policy to the device. In this example, a health diagnosis is not required for full network access. When an operator selects download application link 820, an application is downloaded and installed on the device that checks the state of any health system agent on the device and, if no health system agent is present on the device, downloads and installs a health system agent onto the device.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

I/We claim:

1. A computer-readable medium whose contents are capable of causing a computing system to perform a method for discerning network host health in a network, the method comprising:
monitoring traffic on the network to observe (a) statements of health sent by hosts connected to the network and (b) traffic of at least one other type sent by hosts connected to the network;
maintaining a list of hosts connected to the network from which a statement of health has been observed; and
when traffic of the other type is observed from a host connected to the network that is not included in the maintained list, taking an action intended to cause the host to send a statement of health.

2. The computer-readable medium of claim 1 wherein the action taken is installing a system health agent on the host.

3. The computer-readable medium of claim 1 wherein the action taken is directing the user of the host to install a system health agent on the host.

4. The computer readable medium of claim 3, further comprising:
determining that the user has not installed a system health agent on the host; and
in response to the determining, limiting the types of network traffic that can be sent from the host.

5. The computer-readable medium of claim 1 wherein the action taken is activating a system health agent installed on the host.

6. The computer-readable medium of claim 1 wherein the action taken is directing the user of the host to activate a system health agent installed on the host.

7. The computer readable medium of claim 6, further comprising:
determining that the user has not activated the system health agent installed on the host; and
in response to the determining, limiting the types of network traffic that can be sent from the host.

8. The computer-readable medium of claim 1, further comprising, for each network host from which a statement of health is observed, establishing network access rights for the host in accordance with the contents of the statement of health.

9. A method for discerning network host health in a network, comprising:
in a device connected to the network, monitoring traffic on the network to observe (a) statements of health sent by hosts connected to the network and (b) traffic of at least one other type sent by hosts connected to the network;
when traffic of the other type is observed from a host connected to the network from which no statement of health has been observed, providing communication to a user of the host offering a first alternative of installing and/or activating a system health agent on the host, and a second alternative of having network access control restrictions imposed on the host;
if the user of the host elects the first alternative, assisting the user of the host in installing and/or activating a system health agent on the host; and
if the user of the host elects the second alternative, causing network access control restrictions to be imposed on the host.

10. The method of claim 9 wherein the provided communication is a web page served to the user of the host.

11. The method of claim 9 wherein the provided communication is a web page served to the user of the host in place of a web page requested by the user of the host.

12. The method of claim 9 wherein the provided communication is an e-mail message transmitted to the user of the host.

13. The method of claim 12, further comprising intercepting SMTP traffic from the host to discern an e-mail address of the user of the host, wherein the provided communication is transmitted to the discerned e-mail address.

14. The method of claim 12, further comprising intercepting POP traffic from the host to discern an e-mail address of the user of the host, wherein the provided communication is transmitted to the discerned e-mail address.

15. The method of claim 12, further comprising intercepting IMAP traffic from the host to discern an e-mail address of the user of the host, wherein the provided communication is transmitted to the discerned e-mail address.

16. A system for tracking the state of health of devices connected to a network, the system comprising:
a component that receives a statement of health from at least one device connected to the network;
a component that generates a diagnosis for the at least one device connected to the network based on the received statement of health;
a component that maintains a list of devices connected to the network for which a health diagnosis has been generated; and
a component that, in response to receiving data from an undiagnosed device, causes the operator of the device to be prompted to take action to enable the reporting of a statement of health.

17. The system of claim 16, further comprising:
a component that specifies a set of network access control restrictions to be applied to undiagnosed devices; and
a component that insulates a portion of the network that contains devices with a healthy diagnosis from undiagnosed devices.

18. The system of claim 17, further comprising:
a component that insulates the portion of the network that contains devices with a healthy diagnosis from devices with an unhealthy diagnosis.

19. The system of claim 16, further comprising:
a component that captures HTTP requests from undiagnosed devices and redirects the HTTP requests to a web page maintained by the system, wherein the web page is configured to provide an operator of a device with instructions and/or software for enabling health reporting.

20. The system of claim 16, further comprising:
a component that observes SMTP, POP, or IMAP traffic for the purpose of obtaining an operator email address to direct information and instructions for enabling health reporting.

21. The system of claim 16, further comprising:
a component that, in response to receiving data from an unhealthy device, notifies an operator of the device that the device is unhealthy and allows the device to access the network without correcting the health of the device.

22. The system of claim 16, further comprising:
a component that, in response to receiving data from an unhealthy device, causes the device to take action to automatically correct the health of the device.

23. The system of claim 16, further comprising:
a component that, in response to receiving data from an unhealthy device, notifies an administrator of the network that the device is accessing the network.

24. A method performed by a computer having a memory and a processor, the method comprising:
monitoring traffic on a network to observe (a) statements of health sent by devices connected to the network and (b) traffic of at least one other type sent by devices connected to the network; and
when traffic is observed from a device connected to the network from which a statement of health indicating that the device is healthy has not been received, sending a notification that the device is accessing the network without providing a statement of health indicating that the device is healthy.

25. The method of claim 24 wherein sending the notification includes sending the notification to an operator of the device.

26. The method of claim 24 wherein sending the notification includes sending the notification to an administrator of the network.
